(19) United States
(12) Patent Application Publication
(10) Pub. No.: US 2025/0103871 A1
(43) Pub. Date: Mar. 27, 2025

(54) Systems and Methods for Enhancing the Signal-to-Noise Ratio in Analog Implementations of Trained Neural Networks

(71) Applicant: PolyN Technology Limited, Bristol (GB)

(72) Inventors: Dmitrii Godovskii, Bucharest (RO); Boris Maslov, Palmetto, FL (US); Aleksandrs Timofejevs, Riga (LV)

(21) Appl. No.: 18/975,129

(22) Filed: Dec. 10, 2024

Related U.S. Application Data
(63) Continuation-in-part of application No. 17/196,960, filed on Mar. 9, 2021.
Application No. 17/196,960 is a continuation-in-part of application No. 17/189,109, filed on Mar. 1, 2021.
Application No. 17/189,109 is a continuation-in-part of application No. PCT/EP2020/067800, filed on Jun. 25, 2020.
Application No. PCT/EP2020/067800 is a continuation of application No. PCT/RU2020/000306, filed on Jun. 25, 2020.

(51) Int. Cl. G06N 3/065; G06N 3/0495

(52) U.S. Cl. CPC G06N 3/065; G06N 3/0495

(57) ABSTRACT

The various implementations described herein include methods for improving signal-to-noise ratios of analog circuit implementations of neural networks. In one aspect, a method includes quantizing weights of a trained neural network to form a quantized neural network having a quantized output neuron in a final nth layer. The method also includes forming a second neural network having: n+1 layers; layers 1, . . . , n−1 identical to respective layers 1, . . . , n−1 of the trained neural network; an nth layer that includes a plurality of neurons identical to the output neuron; and an (n+1)th layer that includes one neuron that computes the average from the plurality of neurons in the nth layer. The method further includes transforming the quantized second neural network into an analog network by computing a weight matrix for the analog network, and generating a schematic for the analog network.

### CROSS-REFERENCE TO RELATED APPLICATIONS

This application is a continuation-in-part of U.S. application Ser. No. 17/196,960, filed Mar. 9, 2021, entitled “Analog Hardware Realization of Trained Neural Networks for Voice Clarity,” which is a continuation-in-part of U.S. application Ser. No. 17/189,109, filed Mar. 1, 2021, entitled “Analog Hardware Realization of Neural Networks”, each of which is incorporated by reference herein in its entirety. U.S. application Ser. No. 17/189,109 is a continuation-in-part of PCT Application PCT/EP2020/067800, filed Jun. 25, 2020, entitled “Analog Hardware Realization of Neural Networks,” which is incorporated by reference herein in its entirety. U.S. application Ser. No. 17/189,109 is also a continuation of PCT Application PCT/RU2020/000306, filed Jun. 25, 2020, entitled “Analog Hardware Realization of Neural Networks,” which is incorporated by reference herein in its entirety.

### TECHNICAL FIELD

The disclosed implementations relate generally to neural networks and more specifically to systems and methods of improving the signal-to-noise ratio of outputs from neural networks (e.g., trained for voice clarity).

### BACKGROUND

Voice transmissions comprise the majority of communications between humans and human-machine interfaces, and substantially surpass video and hand-typed communications. Clarity of voice transmission needs to be maintained while voice signals are compressed or digitized for transmission. Traditionally, multiple noise suppression and noise filtering methods and apparatuses process the unclear voice signals and remove at least some of the unwanted noise. Some conventional techniques use microphones that capture noise and generate sounds that effectively cancel out the unwanted noises detected around a listener. Such techniques are more prevalent in headphones, and specifically in noise-cancelling headphones. There are also techniques that suppress certain noises based on spectra qualities of specific noise sources, or using more elaborate algorithms, such as Markov processes, Fast Fourier Transform methods, and various noise-detecting adaptive algorithms.

More recently, neural networks have been used to analyze signals containing a mix of voice and noise, and to effectively extract mostly voice-containing signals, based on the specific features attributable to voice. Such neural networks can be transformed into analog circuits that model trained neural networks (also referred to as equivalent analog circuits). These equivalent analog circuits can provide improved performance per watt advantages, can be useful in implementing hardware solutions in edge environments, and can tackle a variety of applications, such as drone navigation and autonomous cars.

The transformation of neural networks from software to hardware is a hardware implementation of an ideal software-based neural network, which can result in increased noise due to the discrete nature of hardware or analog components. In some cases, noise can be heard (e.g., perceived by a human ear) in the analog signal output from an equivalent analog circuit used for acoustic signal transformation. Thus, there is a need for methods of reducing noise in equivalent analog circuits, thereby improving the signal-to-noise ratio of equivalent analog circuits (e.g., analog circuits that are hardware implementations of neural networks).

### SUMMARY

Accordingly, there is a need for methods, circuits and/or interfaces that address at least some of the deficiencies identified above. Neural networks and equivalent analog circuits that model trained neural networks and are manufactured according to the techniques described herein can provide improved signal-to-noise ratios compared to equivalent analog circuits that do not include a noise reduction layer as described here.

The techniques described here can be used to design and/or manufacture an analog neuromorphic integrated circuit (e.g., an equivalent analog circuit) that is mathematically equivalent to a trained neural network (e.g., either a feed-forward neural network or a recurrent neural network) and includes a noise reduction layer that reduces noise that may be introduced in a hardware implementation of a neural network. In this way, output produced by an equivalent analog circuit that includes a noise reduction layer has a higher signal-to-noise ratio than output produced by an equivalent analog circuit that does not include the noise reduction layer.

According to some implementations, the process begins with obtaining a trained neural network (e.g., a high bit precision neural network), which includes an output neuron in a final n^{th} layer of the trained neural network. A second neural network is generated based on the trained neural network. The second neural network includes layers 1 through (n−1) that are identical to layers 1 through (n−1) of the trained neural network. The nth layer of the second neural network (also referred to as the noise reduction layer) includes a plurality of neurons that are identical to the output neuron of the trained neural network. The second neural network also includes a final (n+1)^{th} layer that includes a single neuron, which computes the average of output signals from the plurality of neurons in the nth layer of the second neural network. The second neural network is quantized to generate a quantized neural network (e.g., a low bit precision neural network or a neural network that includes a plurality of neurons that have a low bit precision). The quantized neural network is transformed into an network that includes standard elements. Operations of the analog network are simulated using software with known models representing the standard elements. Software simulation is used to determine the individual resistance values for each of the resistors in the analog network. Lithography masks are laid out based on the arrangement of the standard elements in the analog network. The lithography masks are then used to manufacture analog circuits corresponding to the second quantized neural network. The analog circuit generated based on the quantized neural network produces an output that has a higher signal-to-noise ratio than the signal-to-noise ratio produced from an alternative analog circuit generated based on a first trained neural network (whether before or after weight quantization).

In accordance with some implementations, a method includes obtaining weights of a trained neural network that includes an output neuron in a final nth layer. The method also includes forming an expanded neural network having n+1 layers. The expanded neural network includes layers 1, . . . , n−1, which are identical to respective layers 1, . . . , n−1 of the trained neural network; an nth layer that includes a plurality of neurons that are identical to the output neuron of the trained neural network; and an (n+1)th layer that includes a single neuron that computes the average of output signals from the plurality of neurons in the nth layer. The method further includes quantizing weights of the expanded neural network, transforming the expanded neural network into an equivalent analog network of analog components, and computing a weight matrix for the equivalent analog network based on quantized weights of the quantized neural network. Each element of the weight matrix represents a respective connection between a respective pair of analog components of the equivalent analog network. The method also includes generating a schematic model for implementing the equivalent analog network based on the weight matrix, including selecting component values for the analog components.

In accordance with some implementations, a system for hardware realization of neural networks with improved signal-to-noise ratios includes one or more processors and memory for storing one or more programs configured for execution by the one or more processors. The one or more programs include instructions for obtaining weights of a trained neural network that includes an output neuron in a final nth layer. The one or more programs also include instructions for forming an expanded neural network having n+1 layers. The expanded neural network includes layers 1, . . . , n−1, which are identical to respective layers 1, . . . , n−1 of the first trained neural network; an nth layer that includes a plurality of neurons that are identical to the output neuron of the first trained neural network; and an (n+1)th layer, which includes a single neuron that computes the average of output signals from the plurality of neurons in the nth layer. The one or more programs further include instructions for quantizing weights of the expanded neural network, transforming the expanded neural network into an equivalent analog network of analog components, and computing a weight matrix for the equivalent analog network based on quantized weights of the quantized neural network. Each element of the weight matrix represents a respective connection between analog components of the equivalent analog network. The one or more programs also include instructions for generating a schematic model for implementing the equivalent analog network based on the weight matrix, including selecting component values for the analog components.

In accordance with some implementations, a voice-transmission device includes an integrated circuit for acoustic signal processing. The integrated circuit includes an analog network of analog components corresponding to a neural network trained for acoustic signal processing. The analog components of the analog network are determined based on a weight matrix calculated based on weights of the neural network. The analog network includes a last layer having an output neuron that computes the average of signal inputs from a plurality of identical neurons in an immediately preceding layer. An analog signal output from the output neuron has a signal-to-noise ratio that is greater than the signal-to-noise ratio of the identical neurons in the immediately preceding layer.

In some implementations, a computing device includes one or more processors, memory, a display, and one or more programs stored in the memory. The programs are configured for execution by the one or more processors. The one or more programs include instructions for performing any of the methods described herein.

In some implementations, a non-transitory computer-readable storage medium stores one or more programs configured for execution by a computing device having one or more processors, memory, and a display. The one or more programs include instructions for performing any of the methods described herein.

In various circumstances, the methods and devices of the present disclosure have the following advantages over conventional neural networks. First, in accordance with some implementations, a neural network generated by the method described herein provides an output that has an improved signal-to-noise ratio compared to a similar quantized neural network that does not include a signal-to-noise enhancement layer. Similarly, an analog circuit (e.g., an integrated circuit) that corresponds to a neural network having a signal-to-noise enhancement layer generates an analog output that has a higher signal-to-noise ratio compared to a similar analog circuit that does not include a signal-to-noise enhancement layer.

Thus, methods and systems are disclosed for improving signal-to-noise ratios of equivalent analog circuits. Such methods and systems may complement or replace methods and systems of generating equivalent analog circuits.

### BRIEF DESCRIPTION OF THE DRAWINGS

For a better understanding of the aforementioned systems, methods, and devices, as well as additional systems, methods, and devices that provide hardware realization of neural networks for acoustic signal processing with improved signal-to-noise ratio, reference should be made to the Description of Implementations below, in conjunction with the following drawings in which like reference numerals refer to corresponding parts throughout the figures.

FIG. 1A provides an example process for hardware realization of trained neural networks with improved signal-to-noise ratios using analog components in accordance with some implementations.

FIG. 1B illustrates an example architecture for a first neural network in accordance with some implementations.

FIG. 1C illustrates an example architecture for a second neural network architecture generated based on the first neural network, in accordance with some implementations.

FIG. 2 is a block diagram of an example computing device in accordance with some implementations.

FIGS. 3A and 3B provide a flowchart of an example process for improving the signal-to-noise ratio in neural networks in accordance with some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

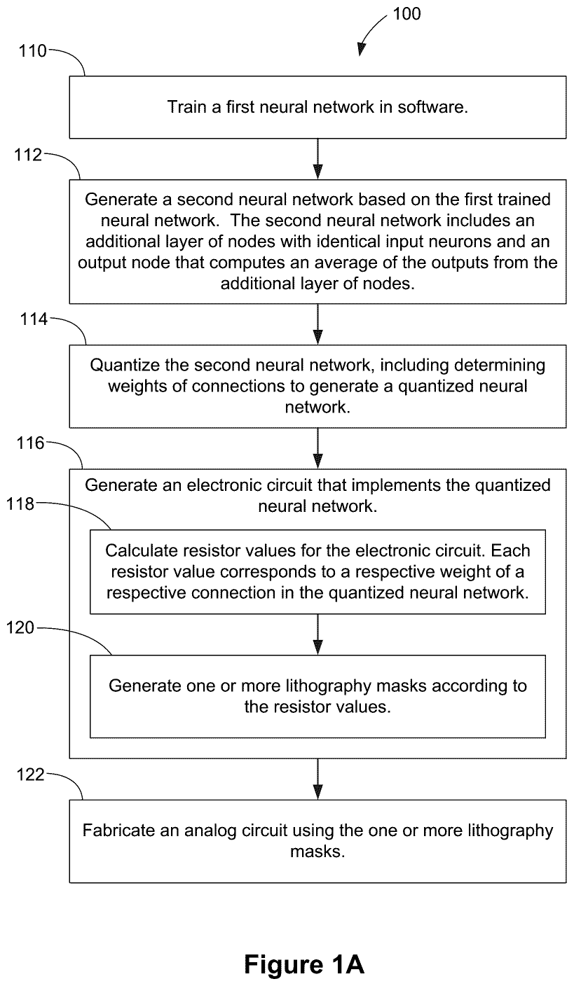

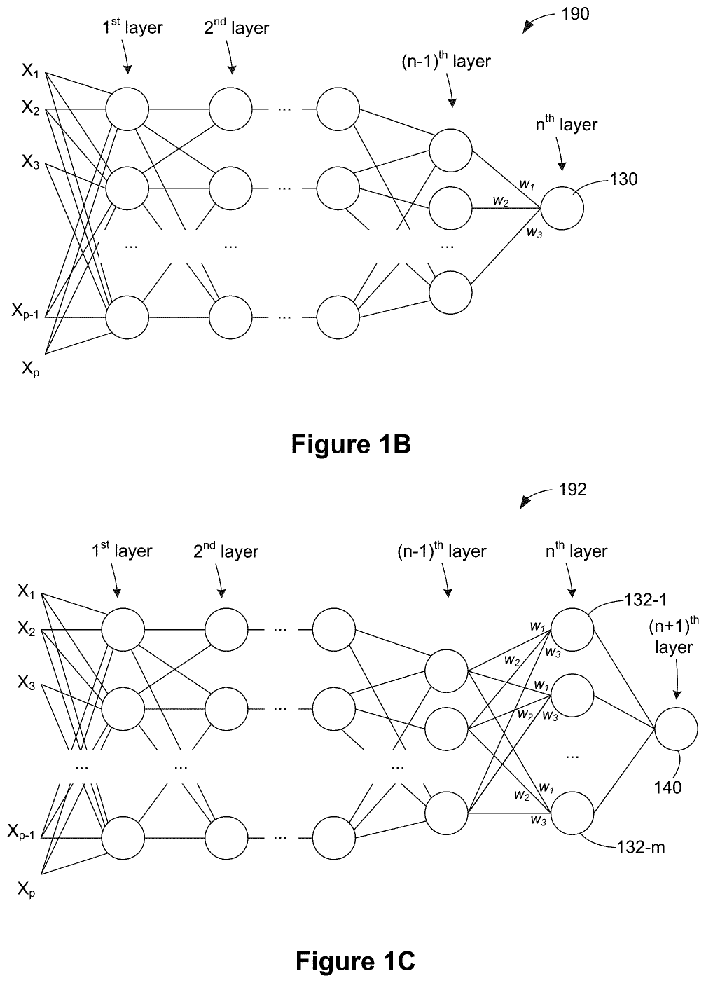

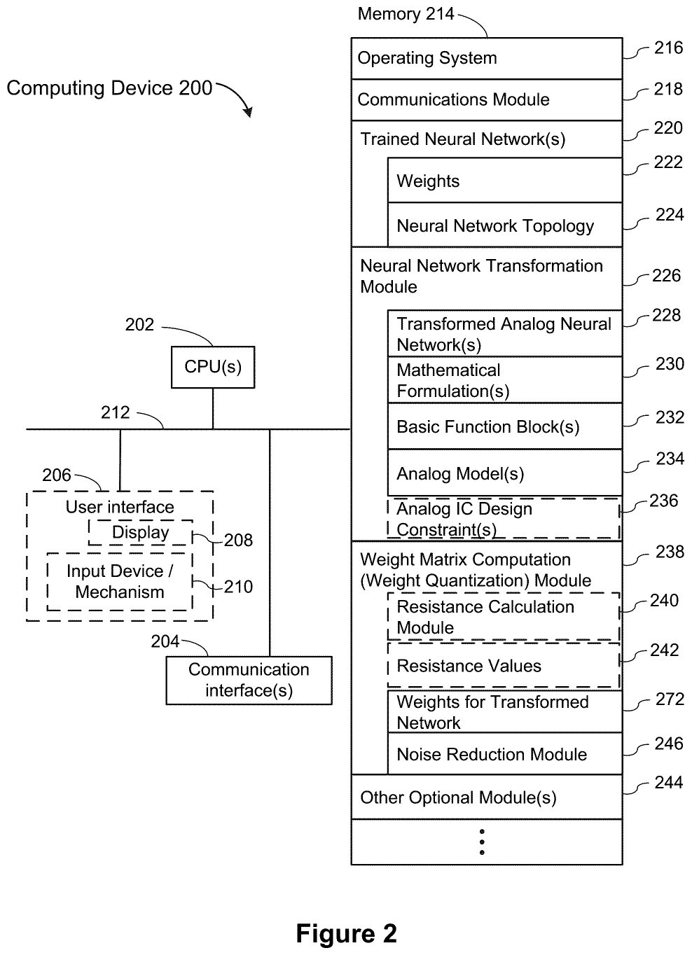

FIG. 1A illustrates an example system 100 for hardware realization of trained neural networks with improved signal-to-noise ratio using analog components in accordance with some implementations. The system 100 includes training (110) a first neural network in software to generate a first trained neural network. In some implementations, the first trained neural network is trained for acoustic signal processing. In some implementations, the first trained neural network is a high bit precision neural network. In some implementations, the first trained neural network has a precision that is greater than 8-bits. The system 100 also includes generating (112) a second neural network based on the first trained neural network. In some implementations, the second neural network includes an additional layer of nodes with identical input neurons and output node that computes the average of the outputs from the additional layer of nodes.

The system quantizes (114) the second neural network, including determining weights of connections to generate a quantized neural network. In some implementations, quantizing the second neural network includes reducing the bit-depth of weights (e.g., reducing the precision of weights) of the second neural network so that the quantized neural network can be used to generate an equivalent analog circuit that corresponds to the second neural network. In some implementations, quantizing the second neural network is part of a weight matrix computation process. In some implementations, the second neural network is originally a high bit precision neural network (e.g., the second neural network is configured to receive inputs having a precision that is greater than 8 bits, the second neural network is configured to produce an output signal having a precision that is greater than 8 bits, the second neural network has a precision that is greater than 8-bits, and/or the second neural network includes a plurality of neurons that have a precision that is greater than 8-bits). In some implementations, the quantized neural network is a low bit precision neural network (e.g., the quantized neural network includes one or more neurons with a precision that is less than or equal to 8-bits, or the quantized neural network is configured to receive one or more inputs that have a precision that is less than or equal to 8-bits). In some implementations, the second neural network has a same precision as the first trained neural network. The system 100 also includes generating (116) an electronic circuit that implements the quantized neural network, including calculating (118) resistor values for the electronic circuit. Each resistor value corresponds (118) to a respective weight of a respective connection in the quantized neural network. The system 100 further includes generating (120) one or more lithography masks according to the resistor values. The system then fabricates (122) an analog circuit (e.g., equivalent analog circuits or integrated circuits) using the lithography masks. Examples of the first trained neural network and the second neural network are provided below with respect to FIGS. 1B and 1C.

FIG. 1B illustrates an example of architecture for a first trained neural network 190 in accordance with some implementations. The first trained neural network 190 includes one or more inputs. In the example provided in FIG. 1B, the first trained neural network 190 has P inputs X₁, X₂, . . . . X₍ₚ₋₁₎, and Xₚ. The first trained neural network 190 also includes a plurality of layers. In the example shown in FIG. 1B, the first trained neural network 190 has n layers, where the final n^{th} layer of the first trained neural network 190 includes an output neuron 130. The first trained neural network 190 is configured to receive inputs (e.g., X₁, . . . , Xₚ) and generate an output signal from the output neuron 130. In some implementations, the first trained neural network 190 is trained for acoustic signal processing, where it receives input audio that includes both voice-features (e.g., voice-component or speech) and non-voice features (e.g., background sounds, background noise, and/or unwanted sounds) and generates a clean version of the input audio including extracted voice-features from the input audio with reduced non-voice features.

In some implementations, the first neural network 190 is a high bit precision network (e.g., it has a bit precision greater than 8 bits, such as 10-bit precision or higher). In some implementations, neurons of the first neural network 190 have a high bit precision (e.g., have a bit precision greater than 8 bits, or have a 10-bit precision or higher). In some implementations, the first neural network 190 is configured to receive one or more inputs having a high precision (e.g., having a bit precision greater than 8 bits, such as 10-bit precision or higher) and generate an output signal having a high bit precision (e.g., the output signal has a bit precision that is greater than 8 bits, such as 10-bit or higher).

FIG. 1C illustrates an example of architecture for a second neural network 192, which is generated based on the first neural network 190, in accordance with some implementations. The second neural network 192 includes one or more inputs. In the example provided in FIG. 1C, the second neural network 192 has P inputs shown as X₁, X₂, . . . . X₍ₚ₋₁₎, and Xₚ. In some implementations, as shown, the second neural network 192 has a same number of inputs as the first trained neural network 190. The second neural network 192 includes a plurality of layers. In the example shown in FIG. 1C, the second neural network has (n+1) layers, which is one layer more than the first trained neural network. The final (n+1)^{th} layer of the second neural network 192 includes an output neuron 140. Layers 1 through (n−1) of the second neural network 192 correspond to (e.g., are the same as) layers 1 through (n−1) of the first trained neural network 190. The n^{th} layer of the second neural network 192 includes a plurality of neurons 132-1, . . . , 132-m (also referred to collectively as neurons 132). All of the neurons 132 are identical to one another and identical to the output neuron 130 of the first trained neural network 190 (e.g., each neuron of the plurality of neurons 132 has the same set of weights, receives the same inputs from the preceding layer, has the same activation function, and/or performs the same calculation). For example, as shown in FIG. 1C, each neuron of the plurality of neurons 132 receives inputs from the neurons of the preceding layer, and each uses weights w₁, w₂, and w₃. The final (n+1)^{th} layer of the second neural network 192 includes an output neuron 140, which computes the average of the identical neurons 132 in the preceding layer (e.g., in the n^{th} layer) to generate an output signal. In some implementations, the second neural network 192 is configured to receive inputs (e.g., X₁, . . . , Xₚ) and generate an output signal from the output neuron 140. In some implementations, the second neural network 192 is trained for acoustic signal processing, where it receives input audio that includes both voice-features (e.g., voice-component or speech) and non-voice features (e.g., background sounds, background noise, and/or unwanted sounds) and generates a clean version of the input audio (e.g., including extracted voice-features from the input audio with reduced non-voice features).

In some implementations, to generate an analog circuit (e.g., an equivalent analog circuit) that is equivalent to the second neural network 192, the second neural network 192 undergoes a weight matrix computation, which includes weight quantization, to form a quantized neural network that corresponds to the second neural network 192. In some implementations, the quantized neural network has a precision that is lower than the precision of the second neural network 192. Since the n^{th} layer of the second neural network 192 includes a plurality of identical neurons 132, the n^{th} layer of the quantized neural network also includes a plurality of neurons (e.g., corresponding to the plurality of identical neurons 132) in the n^{th} layer of the quantized neural network. Similarly, an equivalent analog circuit generated based on the quantized neural network includes a plurality of neurons (e.g., corresponding to the plurality of identical neurons 132).

Typically, when components are fabricated in hardware, there is some amount of error. In particular, the “identical” neurons 132-1, . . . , 132-m are not literally identical, each having a slightly different baked-in noise.

In some implementations, the process of converting the second neural network 192 into an equivalent analog circuit introduces noise into the system. Thus, unlike the identical neurons 132 in the n^{th} layer of the second neural network 192, neurons in the n^{th} layer of the quantized neural network differ from one another slightly due to errors or noise that have been introduced to the system via the weight matrix computation process. Similarly, the analog components in the equivalent analog circuit corresponding to the neurons in the n^{th} layer of the quantized neural network will have values (e.g., resistive values) that differ slightly from one another due to any errors or noise introduced in the process of converting the second neural network 192 (which includes weights that can be represented by continuous values) into an equivalent analog circuit (which is restricted by analog components with discrete values).

In the quantized neural network architecture, the output neuron 140 in the (n+1)^{th} layer of the quantized neural network computes the average of the outputs of the plurality of neurons in the n^{th} layer of the quantized neural network, thereby reducing the noise in the output signal generated by the quantized neural network. The n^{th} layer of the quantized neural network is also referred to as a noise reduction layer, since the plurality of neurons in the n^{th} layer of the quantized neural network leverages signal averaging to reduce the noise and increase the signal-to-noise ratio of the output generated from the quantized neural network.

Similarly, in the equivalent analog circuit generated from the quantized neural network (which is the second neural network 192 with quantized weights), the analog components in the equivalent analog circuit corresponding to the output neuron in the (n+1)^{th} layer of the quantized neural network computes the average of the signals generated by analog components corresponding to the plurality of neurons in the n^{th} layer of the quantized neural network to reduce the noise in the analog output signal produced by the equivalent analog circuit. The analog components in the equivalent analog circuit corresponding to neurons in the n^{th} layer of the quantized neural network leverage signal averaging to reduce the noise and increase the signal-to-noise ratio of the analog output generated from the equivalent analog circuit.

In some implementations, the signal-to-noise ratio of the signal generated by the quantized neural network is improved by an amount that is related to the number M of identical neurons in the n^{th} layer of the quantized neural network (e.g., proportional to M or proportional to \sqrt{M}) compared to the signal-to-noise ratio of the signal generated by another quantized neural network generated by quantizing the first trained neural network 190. Thus, increasing the number of identical neurons in the n^{th} layer of the quantized neural network increases the amount of improvement in the signal-to-noise ratio of the quantized neural network.

In some implementations, the signal-to-noise ratio of the signal generated by the quantized neural network is improved by the square root of the number of identical neurons in the n^{th} layer of the quantized neural network (e.g., \sqrt{M}) compared to the signal-to-noise ratio of the signal generated by another quantized neural network generated by quantizing the first trained neural network 190.

In some implementations, a signal-to-noise ratio of the signal generated by an analog circuit that is equivalent to the quantized neural network is improved by an amount that is proportional to the number of neurons M in the noise reduction layer (e.g., the n^{th} layer) of the quantized neural network (e.g., proportional to M) compared to a signal-to-noise ratio of the analog signal generated by another analog circuit that is equivalent to the first trained neural network 190, after weight quantization.

In some implementations, the signal-to-noise ratio of the signal generated an analog circuit that is equivalent to the quantized neural network is improved by the square root of the number of identical neurons in the noise reduction layer (e.g., the n^{th} layer) of the quantized neural network (i.e., by \sqrt{M}) compared to the signal-to-noise ratio of the signal generated by another analog circuit that is equivalent to the first trained neural network 190, after weight quantization.

In some implementations, the presence of noise in the analog output signal generated by the equivalent analog circuit that is equivalent to the quantized neural network is loud enough to be heard by a human ear (e.g., a naked human ear with no additional sound processing). In some implementations, the number M of neurons in the n^{th} layer of the quantized neural network corresponding to the equivalent analog circuit is selected to improve the signal-to-noise ratio of the analog output signal generated by the analog circuit to appreciable levels so that the noise is not readily perceived by a human ear (e.g., a naked human ear with no additional sound processing).

In some implementations, the n^{th} layer of the second neural network includes at least 2 identical neurons corresponding to the output neuron 130 of the first neural network (e.g., M has a value that is equal to 2 or higher). In some implementations, the n^{th} layer of the second neural network includes 15 or fewer identical neurons corresponding to the output neuron 130 of the first neural network (e.g., M has a value that is equal to 15 or lower).

In some implementations, the n^{th} layer of the quantized neural network includes at least 2 neurons (e.g., M has a value that is equal to 2 or higher). In some implementations, the n^{th} layer of the quantized neural network includes 15 or fewer identical neurons (e.g., M has a value that is equal to 15 or lower).

In some implementations, the inclusion of the noise reduction layer in the quantized neural network allows the quantized neural network to emulate a neural network that has a higher bit precision than the quantized neural network.

In some implementations, the quantized neural network is configured to receive one or more inputs having a low bit precision and produce an output signal that has a higher bit precision than the one or more inputs. In some implementations, the neurons in layers 1 to n of the quantized neural network have a low bit precision compared to an output neuron in layer (n+1) of the quantized neural network (e.g., neurons in layers 1 to n of the quantized neural network have a low bit precision and the output neuron in layer (n+1) of the quantized neural network has a high bit precision). For example, the quantized neural network may be configured to receive inputs that have 8-bit precision, and each neuron in layers 1 to n of the quantized neural network has a precision of 8 bits. The output neuron in layer (n+1) of the quantized neural network has a precision of 10 bits and is configured to generate an output signal having a precision of 10 bits.

In some implementations, the equivalent analog circuit corresponding to the quantized neural network is configured to receive one or more inputs having a low bit precision (e.g., a low bit depth, or a low resolution) and produce an analog output signal that has a higher bit precision (e.g., a higher bit depth or a higher resolution) than the one or more inputs. For example, the equivalent analog circuit may be configured to receive input (e.g., corresponding to audio) that has 8-bit precision and is configured to generate an output analog signal having 10-bit precision (e.g., configured to produce analog signal having a higher resolution than the received input).

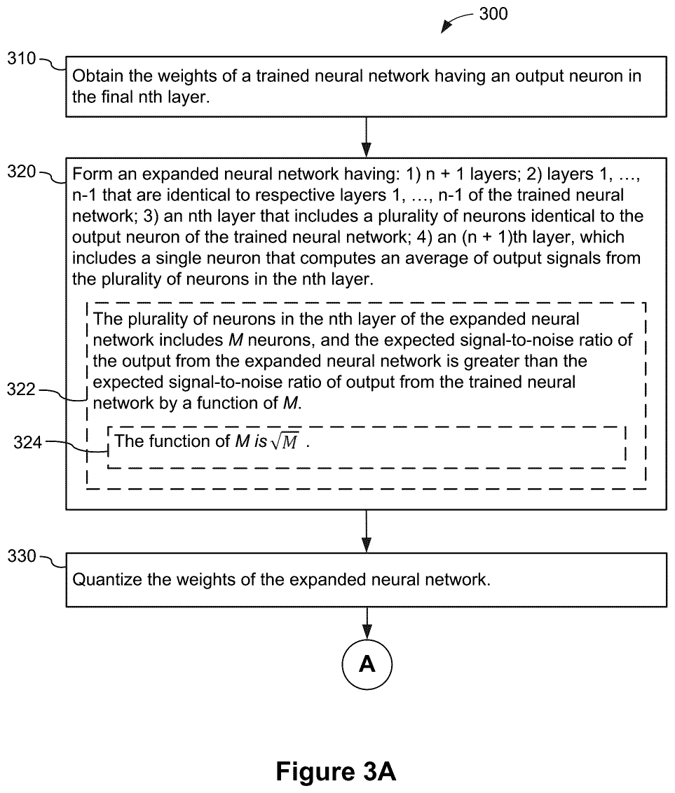

FIG. 2 is a block diagram of an example computing device in accordance with some implementations.

In some implementations, the system 100 described above is implemented or performed by one or more computing devices or server systems as computing modules. FIG. 2 is a system diagram of a computing device 200 in accordance with some implementations. As used herein, the term “computing device” includes both personal devices and servers. A computing device 200 typically includes one or more processing units/cores (CPUs) 202 for executing modules, programs, and/or instructions stored in the memory 214 and thereby performing processing operations; one or more network or other communications interfaces 204; memory 214; and one or more communication buses 212 for interconnecting these components. The communication buses 212 may include circuitry that interconnects and controls communications between system components. A computing device 200 may include a user interface 206 comprising a display device 208 and one or more input devices or mechanisms 210. In some implementations, the input device/mechanism 210 includes a keyboard; in some implementations, the input device/mechanism includes a “soft” keyboard, which is displayed as needed on the display device 208, enabling a user to “press keys” that appear on the display 208. In some implementations, the display 208 and input device/mechanism 210 comprise a touch screen display (also called a touch sensitive display). In some implementations, the memory 214 includes high-speed random access memory, such as DRAM, SRAM, DDR RAM, or other random access solid state memory devices. In some implementations, the memory 214 includes non-volatile memory, such as one or more magnetic disk storage devices, optical disk storage devices, flash memory devices, or other non-volatile solid state storage devices. In some implementations, the memory 214 includes one or more storage devices remotely located from the CPU(s) 202. The memory 214, or alternatively the non-volatile memory devices within the memory 214, comprises a computer readable storage medium. In some implementations, the memory 214, or the computer readable storage medium of the memory 214, stores the following programs, modules, and data structures, or a subset thereof:
an operating system 216, which includes procedures for handling various basic system services and for performing hardware dependent tasks;
a communications module 218, which is used for connecting the computing device 200 to other computers and devices via the one or more communication network interfaces 204 (wired or wireless) and one or more communication networks, such as the Internet, other wide area networks, local area networks, metropolitan area networks, and so on;
trained neural networks 220, which include weights 222 and neural network topologies 224;
a neural network transformation module 226, which produces transformed analog neural networks 228, using mathematical formulations 230, the basic function blocks 232, analog models 234 (sometimes called neuron models), and/or analog integrated circuit (IC) design constraints 236; and
a weight matrix computation module (sometimes called a weight quantization module) 238, which includes weights 272 of transformed networks. In some implementations, this includes a resistance calculation module 240 and resistance values 242. The weight matrix computation module 238 also includes a noise reduction module 246, which generates a neural network architecture with one or more noise reduction layers configured to reduce noise.

Some implementations include one or more optional modules 244, such as an analog neural network optimization module.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise rearranged in various implementations. In some implementations, the memory 214 stores a subset of the modules and data structures identified above. Furthermore, in some implementations, the memory 214 stores additional modules or data structures not described above.

Although FIG. 2 shows a computing device 200, FIG. 2 is intended more as a functional description of the various features that may be present rather than as a structural schematic of the implementations described herein. In practice, and as recognized by those of ordinary skill in the art, items shown separately could be combined and some items could be separated.

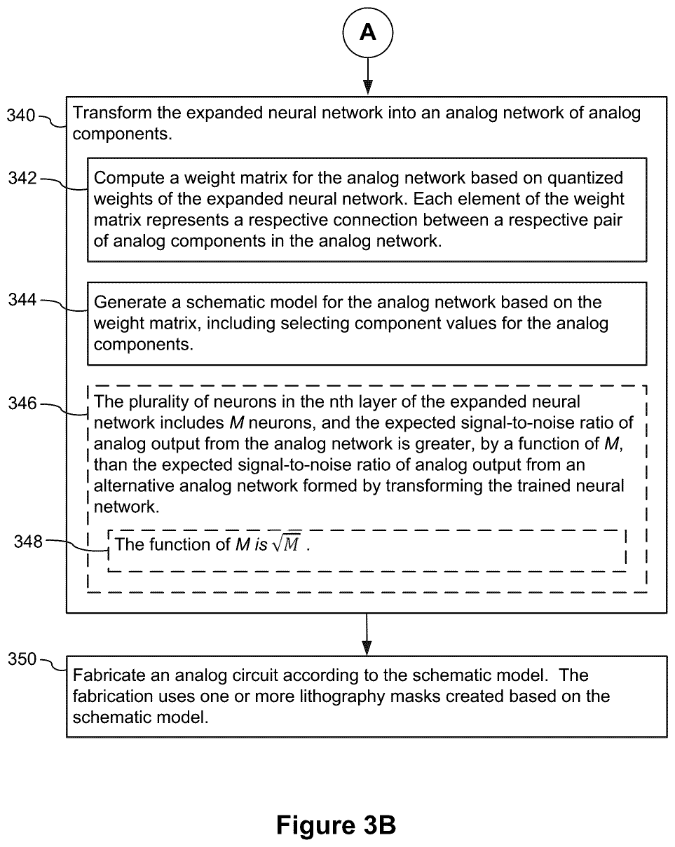

FIGS. 3A and 3B provide a flowchart of an example method 300 (also referred to as a process) for improving the signal-to-noise ratio in neural networks in accordance with some implementations. The method 300 is performed at a computing system 200 having one or more processors and memory. In some implementations, the memory stores one or more programs configured for execution by the one or more processors.

The method 300 includes obtaining (310) weights of a trained neural network 190 (shown in FIG. 1B), which includes an output neuron 130 in the final nth layer. The method 300 also includes forming (320) an expanded neural network 192 (shown in FIG. 1C), which has: 1) n+1 layers; 2) layers 1, . . . , n−1 that are identical to respective layers 1, . . . , n−1 of the trained neural network 190; 3) an nth layer comprising a plurality of neurons (e.g., neurons 132-1, . . . , 132-m, collectively referred to as the plurality of neurons 132), which are identical to the output neuron 130 of the trained neural network 190; and 4) an (n+1)th layer comprising a single neuron 140 that computes the average of output signals from the plurality of neurons 132 in the nth layer. In some implementations, the plurality of neurons in the nth layer of the expanded neural network includes (322) M neurons, and the expected signal-to-noise ratio of output from the expanded neural network is greater than the expected signal-to-noise ratio of output from the trained neural network, by a function of M. In some implementations, the function is (324) \sqrt{M}.

The method 300 further includes quantizing (330) weights of the expanded neural network 192.

The method 300 includes transforming (340) the expanded neural network into an analog network of analog components (e.g., an analog network equivalent to the expanded neural network). The transformation process includes computing (342) a weight matrix for the analog network based on quantized weights of the expanded neural network. Each element of the weight matrix represents a respective connection between a respective pair of analog components in the analog network. The transformation process further includes generating (344) a schematic model for implementing the analog network based on the weight matrix, including selecting component values for the analog components.

In some implementations, the plurality of neurons in the nth layer of the expanded neural network includes (346) M neurons, and the expected signal-to-noise ratio of analog output from the analog network is greater, by a function of M, than the expected signal-to-noise ratio of analog output from an alternative analog network formed by transforming the trained neural network. In some implementations, the function is (348) \sqrt{M}.

In some implementations, the method includes fabricating an analog circuit according to the schematic model. The fabrication uses one or more lithography masks created based on the schematic model.

In some implementations, the expanded neural network is configured to receive input having a first bit precision and produce an output signal having a second bit precision that is higher than the first bit precision.

In some implementations, the expanded neural network includes one or more neurons that have a precision that is less than or equal to 8-bit precision.

In some implementations, the trained neural network was trained for acoustic signal processing.

In some implementations, the analog circuit leverages the following mathematical principles of signal averaging to achieve a reduction in noise and an increase in the signal-to-noise ratio of the analog output generated from the analog circuit.

In some implementations, power of the signal output from an analog circuit can be represented as P_{signal}, and the power of noise in the signal output from the analog circuit can be represented as Pₙₒᵢₛₑ=σ². Thus, the signal-to-noise ratio of the signal output from the analog circuit can be represented as follows:

$$S N R = \frac{{P}_{s i g n a l}}{{P}_{n o i s e}} \\ SNR = \frac{{P}_{s i g n a l}}{{σ}^{2}} .$$

The variance of the noise can be represented as Var(Pₙₒᵢₛₑ)=σ².

The analog circuit includes a noise reduction layer that includes n analog components corresponding to n identical neurons in the neural network (e.g., the second neural network 192) on which the analog circuit is based. Thus, the variance of the noise of the signal, when averaging over n ideally identical signals, can be presented as follows:

$$Var ( {P}_{n o i s e , a v g} ) = \frac{1}{n} ( {\sum }_{i = 1}^{n} {P}_{n o i s e , a v {g}_{i}} ) Var ( {P}_{n o i s e , a v g} ) = \frac{1}{{n}^{{}_{2}}} {\sum }_{i = 1}^{n} Var ( {P}_{n o i s e , a v {g}_{i}} ) Var ( {P}_{n o i s e , a v g} ) = \frac{1}{{n}^{2}} n {σ}^{2} Var ( {P}_{n o i s e , a v g} ) = \frac{{σ}^{2}}{n} .$$

In some implementations, since the standard deviation is the square root of the variance, the original standard deviation is σ, and the standard deviation in the expanded neural network is

$$\frac{σ}{\sqrt{n}} .$$

In some implementations, the signals are substantially identical (e.g., the mean value is substantially identical, the ideal signal is identical, or the signal produced by the analog components corresponds to the identical neurons in the n^{th} layer of the second neural network 192). In such cases, when averaged over n signals, the averaged signal has the power P.

Thus, the signal-to-noise ratio of a signal that is averaged over n substantially identical signals (e.g., the signal-to-noise ratio of a signal output from the analog circuit) can be represented as follows, where P_{signal, avg} is the power of the averaged signal and P_{noise, avg} is the noise of the averaged signal:

$$SN {R}_{a v g} = \frac{{P}_{s i g n al , avg}}{{P}_{n o i se , avg}} \\ SN {R}_{a v g} = {P}_{signal} \frac{n}{{σ}^{2}} \\ SN {R}_{a v g} = n S N R .$$

Thus, in some implementations, by generating an analog circuit that includes analog components corresponding to a neural network (e.g., the second neural network 192) that includes a noise reduction layer having n identical neurons (e.g., the neurons 132 in the n^{th} layer of the second neural network 192), the signal-to-noise ratio of a signal generated by the analog circuit can be improved, in the theoretical ideal case, by n times. That is, the signal-to-noise ratio is n times better than an alternative analog circuit that is formed based on the original neural network (such as the first neural network 190), which does not include the noise reduction layer.

Turning now to some example implementations.

(A1) Some implementations include a method for improving signal-to-noise ratios of neural networks. The method includes obtaining weights of a trained neural network that includes an output neuron in a final nth layer. The method also includes forming an expanded neural network having n+1 layers. The expanded neural network includes layers 1, . . . , n−1, which are identical to respective layers 1, . . . , n−1 of the trained neural network; an nth layer that includes a plurality of neurons that are identical to the output neuron of the trained neural network; and an (n+1)th layer that includes a single neuron that computes the average of output signals from the plurality of neurons in the nth layer. The method further includes quantizing weights of the expanded neural network and transforming the expanded neural network into an analog network of analog components, by computing a weight matrix for the analog network based on quantized weights of the expanded neural network. Each element of the weight matrix represents a respective connection between a respective pair of analog components of the analog network. The method also includes generating a schematic model for implementing the analog network based on the weight matrix, including selecting component values for the analog components.

(A2) The method of A1, where the expected signal-to-noise ratio of analog output from the analog network is greater than the expected signal-to-noise ratio of analog output from an alternative analog network generated based on the trained neural network, by a function of M, where M is the number of identical neurons in the nth layer.

(A3) The method of A1 or A2, where the plurality of neurons in the nth layer of the expanded neural network includes M neurons, and the expected signal-to-noise ratio of analog output from the analog network is greater than the expected signal-to-noise ratio of analog output from an alternative analog network generated based on the trained neural network, by the factor \sqrt{M}.

(A4) The method of any of A1-A3, where the expanded neural network is configured to receive input having a first bit precision and produce an output having a second bit precision that is higher than the first bit precision.

(A5) The method of any of A1-A4, where the expanded neural network includes one or more neurons that have a precision that is less than or equal to 8-bit precision.

(A6) The method of any of A1-A5, where the trained neural network was trained for acoustic signal processing.

(B1) Some implementations include a system for hardware realization of neural networks with improved signal-to-noise ratios. The system includes one or more processors and memory for storing one or more programs configured for execution by the one or more processors. The one or more programs include instructions for obtaining weights of a trained neural network that includes an output neuron in a final nth layer. The one or more programs also include instructions for forming an expanded neural network having n+1 layers. The expanded neural network includes layers 1, . . . , n−1, which are identical to respective layers 1, . . . , n−1 of the trained neural network; an nth layer that includes a plurality of neurons that are identical to the output neuron of the trained neural network; and an (n+1)th layer, which includes a single neuron that computes the average of output signals from the plurality of neurons in the nth layer. The one or more programs further include instructions for quantizing weights of the expanded neural network. The one or more programs also include instructions for transforming the expanded neural network into an analog network of analog components, including computing a weight matrix for the analog network based on quantized weights of the expanded neural network. Each element of the weight matrix represents a respective connection between a respective pair of analog components of the analog network. The one or more programs also include instructions for generating a schematic model for implementing the analog network based on the weight matrix, including selecting component values for the analog components.

(B2) The system of B1, where the plurality of neurons in the nth layer of the expanded neural network includes M neurons, and the expected signal-to-noise ratio of analog output from the analog network is greater than the expected signal-to-noise ratio of analog output from the analog network generated based on the trained neural network, by a function of M.

(B3) The system of B1 or B2, where the plurality of neurons in the nth layer of the expanded neural network includes M neurons, and the expected signal-to-noise ratio of analog output from the analog network is greater than the expected signal-to-noise ratio of analog output from an alternative analog network generated based on the trained neural network, by \sqrt{M}.

(B4) The system of any of B1-B3, where the expanded neural network is a low bit precision neural network.

(B5) The system of any of B1-B4, where the expanded neural network has a precision that is less than or equal to 8-bit precision

(B6) The system of any of B1-B5, where the trained neural network was trained for acoustic signal processing.

(C1) Some implementations include an integrated circuit for acoustic signal processing. The integrated circuit includes an analog network of analog components corresponding to a neural network trained for acoustic signal processing. The analog components of the analog network are determined based on a weight matrix calculated based on weights of the neural network. The analog network includes a last layer having an output neuron that computes the average of signal inputs from a plurality of identical neurons in an immediately preceding layer. The analog signal output from the output neuron has a signal-to-noise ratio that is greater than the signal-to-noise ratio of the identical neurons in the immediately preceding layer.

(C2) The integrated circuit of C1, where the voice-transmission device is integrated into a cell phone.

(C3) The integrated circuit of C1 or C2, where a microphone of the cell phone provides input to the integrated circuit.

(C4) The integrated circuit of any of C1-C3, where output from the integrated circuit is connected to a speaker of the cell phone.

(C5) The integrated circuit of any of C1-C4, where the integrated circuit is coupled to one or more other noise cancelling devices and/or coupled to one or more noise reduction software programs executing on the voice-transmission device.

(C6) The integrated circuit of any of C1-C5, where the neural network is configured to receive input having a first bit precision and produce an output signal having a second bit precision that is higher than the first bit precision.

(C7) The integrated circuit of any of C1-C6, where the neural network includes one or more neurons that have a precision that is less than or equal to 8-bit precision.

(C8) The integrated circuit of any of C1-C7, where the weights of the neural network are quantized weights.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method for improving signal-to-noise ratios of neural networks, comprising:
obtaining weights of a trained neural network having an output neuron in a final nth layer;
forming an expanded neural network having n+1 layers, including:
layers 1, . . . , n−1 identical to respective layers 1, . . . , n−1 of the trained neural network;
an nth layer comprising a plurality of neurons identical to the output neuron of the trained neural network; and
an (n+1)th layer comprising a single neuron that computes an average of output signals from the plurality of neurons in the nth layer;
quantizing weights of the expanded neural network;
transforming the expanded neural network into an equivalent analog network of analog components, including:
computing a weight matrix for the equivalent analog network based on the quantized weights of the expanded neural network, each element of the weight matrix representing a respective connection between a respective pair of analog components of the equivalent analog network; and
generating a schematic model for implementing the equivalent analog network based on the weight matrix, including selecting component values for the analog components.

2. The method of claim 1, wherein:
the plurality of neurons in the nth layer of the expanded neural network includes M neurons; and
an expected signal-to-noise ratio of analog output from the equivalent analog network is greater than an expected signal-to-noise ratio of analog output from an alternative analog network generated based on the trained neural network, by a function of M.

3. The method of claim 1, wherein
the plurality of neurons in the nth layer of the expanded neural network includes M neurons; and
an expected signal-to-noise ratio of an analog output from the equivalent analog network is greater than an expected signal-to-noise ratio of an analog output from an alternative analog network generated based on the trained neural network, by \sqrt{M}.

4. The method of claim 1, wherein the expanded neural network is configured to receive input having a first bit precision and produce an output signal having a second bit precision that is higher than the first bit precision.

5. The method of claim 1, wherein the expanded neural network includes one or more neurons that have a precision that is less than or equal to 8-bit precision.

6. The method of claim 1, wherein the trained neural network was trained for acoustic signal processing.

7. A system for hardware realization of neural networks with improved signal-to-noise ratios, comprising:
one or more processors; and
memory, wherein the memory stores one or more programs configured for execution by the one or more processors, and the one or more programs include instructions for:
obtaining weights of a trained neural network having an output neuron in a final nth layer;
forming an expanded neural network having n+1 layers, including:
layers 1, . . . , n−1 identical to respective layers 1, . . . , n−1 of the trained neural network;
an nth layer comprising a plurality of neurons identical to the output neuron of the trained neural network; and
an (n+1)th layer comprising a single neuron that computes an average of output signals from the plurality of neurons in the nth layer;
quantizing weights of the expanded neural network;
transforming the expanded neural network into an equivalent analog network of analog components, including:
computing a weight matrix for the equivalent analog network based on the quantized weights of the expanded neural network, each element of the weight matrix representing a respective connection between a respective pair of analog components of the equivalent analog network; and
generating a schematic model for implementing the equivalent analog network based on the weight matrix, including selecting component values for the analog components.

8. The system of claim 7, wherein:
the plurality of neurons in the nth layer of the expanded neural network includes M neurons; and
an expected signal-to-noise ratio of analog output from the equivalent analog network is greater than an expected signal-to-noise ratio of analog output from an alternative analog network generated based on the trained neural network, by a function of M.

9. The system of claim 7, wherein:
the plurality of neurons in the nth layer of the expanded neural network includes M neurons; and
an expected signal-to-noise ratio of analog output from the equivalent analog network is greater than an expected signal-to-noise ratio of analog output from an alternative analog network generated based on the trained neural network, by \sqrt{M}.

10. The system of claim 7, wherein the expanded neural network is configured to receive input having a first bit precision and produce an output signal having a second bit precision that is higher than the first bit precision.

11. The system of claim 7, wherein the expanded neural network includes one or more neurons that have a precision that is less than or equal to 8-bit precision.

12. The system of claim 7, wherein the trained neural network was trained for acoustic signal processing.

13. A voice-transmission device, comprising:
an integrated circuit for acoustic signal processing, the integrated circuit comprising an analog network of analog components corresponding to a neural network trained for acoustic signal processing, wherein:
the analog components of the analog network are determined based on a weight matrix calculated based on weights of the neural network;
the analog network includes a last layer having an output neuron that computes an average of signal inputs from a plurality of identical neurons in an immediately preceding layer; and
an analog signal output from the output neuron has a signal-to-noise ratio that is greater than a signal-to-noise ratio of the identical neurons in the immediately preceding layer.

14. The voice-transmission device of claim 13, wherein the voice-transmission device is integrated into a cell phone.

15. The voice-transmission device of claim 14, wherein a microphone of the cell phone provides input to the integrated circuit.

16. The voice-transmission device of claim 14, wherein output from the integrated circuit is connected to a speaker of the cell phone.

17. The voice-transmission device of claim 13, wherein the integrated circuit is coupled to one or more other noise cancelling devices and/or coupled to one or more noise reduction software programs executing on the voice-transmission device.

18. The voice-transmission device of claim 13, wherein the neural network is configured to receive input having a first bit precision and produce an output signal having a second bit precision that is higher than the first bit precision.

19. The voice-transmission device of claim 13, wherein the neural network includes one or more neurons that have a precision that is less than or equal to 8-bit precision.

20. The voice-transmission device of claim 13, wherein the weights of the neural network are quantized weights.
